(19) United States
(12) Patent Application Publication
(10) Pub. No.: US 2025/0224102 A1
(43) Pub. Date: Jul. 10, 2025

(54) CONTROL METHOD FOR LIGHTING SYSTEM, LIGHTING SYSTEM AND STORAGE MEDIUM

(71) Applicant: Aputure Imaging Industries Co., Ltd., Shenzhen (CN)

(72) Inventors: Jun ZHONG, Shenzhen (CN); Haodong ZHOU, Shenzhen (CN); Yao DU, Shenzhen (CN)

(73) Assignee: Aputure Imaging Industries Co., Ltd., Shenzhen (CN)

(21) Appl. No.: 18/949,963

(22) Filed: Nov. 15, 2024

(30) Foreign Application Priority Data
Jan. 5, 2024 (CN) 202410017007.8

(51) Int. Cl. F21V 21/15

(52) U.S. Cl. CPC F21V 21/15

(57) ABSTRACT

A control method for a lighting system, a lighting system, and a storage medium are provided. The method includes steps of receiving a control instruction for the electric bracket, acquiring accessory information of the accessory based on the control instruction, determining control parameters of the electric bracket which are configured for the lighting device, based on the accessory information, and calibrating the electric bracket based on the control parameters.

### CROSS-REFERENCE TO RELATED APPLICATION

This application claims priority to and the benefit of Chinese Patent Application No. 202410017007.8, filed on Jan. 5, 2024, the disclosure of which is incorporated herein by reference in its entirety.

### TECHNICAL FIELD

The present application relates to the technical field of lighting devices, and more particularly, to a control method for a lighting system, a lighting system, and a storage medium.

### BACKGROUND

Currently, projected lighting devices are widely used. Taking a projection lamp in the lighting system as an example, in a projection field, the projection lamp is mounted on a bracket, and when images of different lamplight scenes needs to be photographed, the projection lamp is manually adjusted. However, the large-sized projection lamp is large in volume, and in a film field, it is difficult to use and operate this large-sized projection lamp by manual adjustment, which is difficult to ensure the light quality of the projection lamp. Therefore, there is a need to improve the control scheme of a new lighting system in order to improve the operation convenience and the safety of the large-sized projection lamp.

### SUMMARY

According to embodiments of the present application, it is provided a control method for a lighting system, a lighting system, and a storage medium to solve the technical problems of cumbersome operation and low safety in manually adjusting the lighting system.

In a first aspect, the present application provides a control method for a lighting system,
in which the lighting system includes a lighting device and an electric bracket, the lighting device is mounted on the electric bracket, the electric bracket is configured to adjust an angle of the lighting device; the lighting device includes an lamp body and an accessory interconnected, the lamp body is configured for emitting light, the accessory is configured to adjust the light emitted by the lamp body; the control method includes:
receiving a control instruction for the electric bracket;
acquiring accessory information of the accessory based on the control instruction;
determining control parameters of the electric bracket which are configured for the lighting device, based on the accessory information;
calibrating the electric bracket based on the control parameters.

In a second aspect, the present application provides a lighting system including a lighting device, an electric bracket, and a controller, the electric bracket is communicatively connected to the controller, in which:
the lighting device is mounted on the electric bracket, and the electric bracket is configured to adjust an angle of the lighting device;
the lighting device is mounted on the electric bracket, and the electric bracket is configured to adjust an angle of the lighting device;
the lighting device includes an lamp body and an accessory interconnected, the lamp body is configured for emitting light, the accessory is configured to adjust the light emitted by the lamp body;
the controller is configured to acquire accessory information of the accessory, determine control parameters of the electric bracket which are configured for the lighting device according to the accessory information, and send the control parameters to the electric bracket;
the electric bracket is configured to calibrate according to the control parameters in response to receiving the control parameters, so as to drive the lighting device to move to adjust the light emitted by the lighting device.

According to a third aspect, the present application provides a computer readable storage medium having computer programs stored therein, the computer programs are executed by a processor to implement the steps in the control method for the lighting system described above.

According to embodiments of the present application, it is provided a control method for a lighting system, a lighting system, and a storage medium. By the method including steps of receiving a control instruction for the electric bracket, acquiring accessory information of the accessory based on the control instruction, determining control parameters of the electric bracket which are configured for the lighting device, based on the accessory information, and calibrating the electric bracket based on the control parameters, the automatic control of the lighting system is realized, the on-site manual control is not required, and the control efficiency, the convenience and the safety of the lighting system are greatly improved.

### BRIEF DESCRIPTION OF THE DRAWINGS

In order that the embodiments of the present application or the technical solutions in the prior art may be more clearly described, reference will now be made briefly to the accompanying drawings required for the description of the embodiments or the prior art, and it will be apparent that the accompanying drawings in the following description are merely some of the embodiments of the present application, and other drawings may be made to those skilled in the art without involving any inventive effort.

In which:

FIG. 1 is a flow chart of a control method for a lighting system according to embodiments of the present application;

FIG. 2 is a flow chart of obtaining accessory information of an accessory according to embodiments of the present application;

FIG. 3 is a schematic structural diagram of a lighting system according to embodiments of the present application;

FIG. 4 is another schematic structural diagram of a lighting system according to embodiments of the present application;

FIG. 5 is yet another schematic structural diagram of a lighting system according to embodiments of the present application; and

FIG. 6 is a block diagram of a configuration of a computer device according to embodiments of the present application.

### DETAILED DESCRIPTION

The technical solution in the embodiments of the present application will be described in a clear and complete manner with reference to the accompanying drawings. Obviously, the described embodiments are only a part of the embodiments of the present application, and not all of the embodiments of the present application. Based on the embodiments of the present application, all other embodiments obtained by a person of ordinary skill in the art without involving any inventive effort are within the scope of the present application.

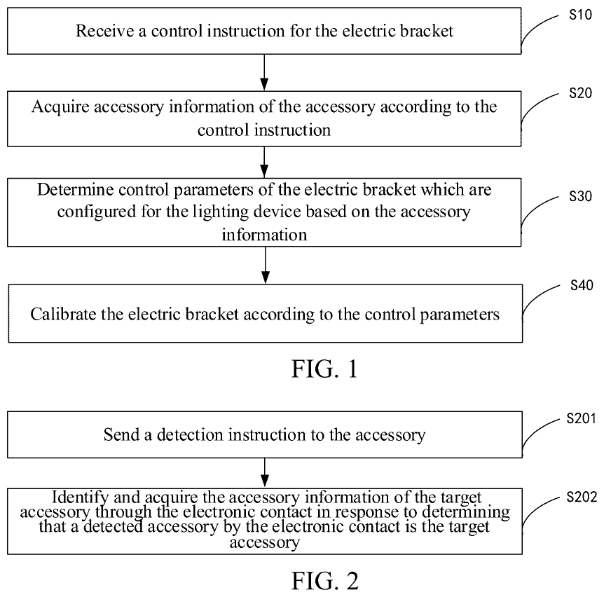

As shown in FIG. 1, according to embodiments of the present application, it is provided a control method for a lighting system including a lighting device and an electric bracket. The lighting device is mounted on the electric bracket, and the electric bracket is used for adjusting an angle of the lighting device. The lighting device includes a lamp body for emitting light, and an accessory interconnected with the lamp body and used for adjusting the light emitted by the lamp body. The control method for the lighting system can be applied to both the terminal and the controller of the lighting system. In the present embodiment, it is exemplified by applying to the controller. In one embodiment, the controller of the lighting system may be integrated with the lamp body. In other embodiments, the controller of the lighting system may be selected to be in a separate design from the lamp body, and the controller and the lamp body may be electrically connected by wires to enable communication, power supply, and the like therebetween.

The control method for the lighting system includes steps S10 to S40.

At step S10, a control instruction for the electric bracket is received.

The accessory refers to an accessory for adjusting a light emitted by a lamp body, such as a softbox, a Fresnel lens, a spotlight, a reflector, a reflective bowl, a standard reflector, or the like. In one use, an accessory connected to the lamp body is usually one, and accessories having different effects can be selected to be used instead according to an actual scene. For example, in order to make the light emitted by the lamp body more soft, the softbox may be selected, particularly for a scene in which soft and natural light is required. In order to produce a narrow and concentrated beam of light for standing out or highlighting a particular area, an object or a person, the spotlight can be selected.

The electric bracket is an electronic bracket that moves to drive the lighting device to move, so as to adjust the light emitted by the lighting device.

The control instruction is an instruction that is from the user side communicatively connected to the controller and used for adjusting the electric bracket to adjust the light emitted by the lighting device to further control the lighting system. For example, the user side may include a using person, or a using terminal such as a mobile phone, a remote control, or a tablet PC. For example, the user side sends the control instruction to the controller by sending voice, an operation key, or input information on an input interface provided, so that the controller receives the control instruction for the electric bracket.

At step S20, accessory information of the accessory is acquired according to the control instruction.

The accessory information refers to information related to the accessory, such as an accessory name, an accessory parameter, a pan rotation angle of the accessory, a tilt rotation angle of the accessory, an origin reset calibration parameter, a locked-rotor calibration parameter, and an accessory size.

Specifically, the accessory information of the accessory can be acquired according to the received control instruction. In one example, if the accessory is a known accessory, i.e. an accessory with pre-configured the accessory information, such as an official accessory, the accessory information of the known accessory may be directly selected. In another example, if the accessory is a known accessory with an electronic contact, the accessory information can be directly identified and acquired by communication between the lamp body and the electronic contact directly. In yet another example, if the accessory is an unknown accessory, such as an unofficial accessory, the accessory information may be obtained according to a control instruction input by the user.

In a particular embodiment, the accessory is one of a target accessory, a known accessory, and an unknown accessory. The target accessory and the known accessory are each an accessory with pre-configured accessory information, the unknown accessory is an accessory with un-configured accessory information, and the target accessory is further provided with an electronic contact for identification and detection. As shown in FIG. 2, the step S20 of acquiring accessory information of the accessory according to the control instruction may include the following steps S201 to S202.

At step S201, a detection instruction is sent to the accessory.

At step S202, in response to determining that a detected accessory by the electronic contact is the target accessory, the accessory information of the target accessory is identified and acquired through the electronic contact.

Specifically, the controller sends a detection instruction to the accessory for detecting the type of the accessory. After the electronic contact detects that the accessory is the target accessory, the accessory information of the target accessory is directly identified and obtained through the electronic contact, thereby automatically determining the accessory and obtaining the accessory information of the accessory.

In a particular embodiment, the step S20 of obtaining the accessory information of the accessory according to the control instruction may include the following steps S203 to S204.

At step S203, in response to determining that the detected accessory is not the target accessory, a selection interface for the unknown accessory and the known accessory is provided for a user side to select.

At step S204, in response to determining that the user side selects the known accessory, the accessory information of the known accessory selected by the user side on the selection interface is acquired.

The selection interface is a User Interface (UI) that is provided by the controller and used for the user side to select the accessory information of both the known accessory and the unknown accessory.

Specifically, when it is detected that the accessory is not a target accessory, the controller provides a selection interface for both the unknown accessory and the known accessory for the user side to select. When the user side selects the known accessory, the accessory information of the known accessory selected by the user side on the selection interface is directly acquired, and is the required accessory information. It can be understood that, since the accessory information of the known accessory has been configured, the accessory information of the known accessory is displayed through the UI. In this way, it is facilitate to select the accessory information for the user side, and thus the accessory information selected by the user is directly determined as the required accessory information. Therefore, there is no needs to manually configure the complicated accessory information, so that the convenience of acquiring the accessory information is ensured, and the visual control of the lighting device is facilitated.

In a specific embodiment, the following step S205 may be included.

At step S205, in response to determining that the user side selects the unknown accessory, a filling interface configured to fill in the control parameters of the electric bracket which are configured for the unknown accessory is provided, to enable the user side to input the control parameters to the filling interface.

The filling interface is a control interface provided by the controller and used for controlling the electric bracket, and the filling interface is used to allow the controller to input the control parameters to set the control parameters of the electric bracket.

Specifically, when the controller detects that the user side selects the unknown accessory, since the accessory information of the unknown accessory is unknown, in order to improve the convenience that the electric bracket controls the unknown accessory, the filling interface of the control parameters of the electric bracket which are configured for the unknown accessory is used in this embodiment, so that the user side can input the control parameters of the electric bracket which are configured for the unknown accessory to the filling interface. In this way, the setting of the control parameters of the electric bracket is realized, so that the automatic calibration of the electric bracket is realized based on the control parameters.

At step S30, control parameters of the electric bracket which are configured for the lighting device are determined based on the accessory information.

The control parameter refers to parameters for controlling the movement of the electric bracket to drive the lighting device. The control parameter is set for the electric bracket. The electric bracket is controlled to move, so as to drive the lighting device to move, thereby adjusting the light emitted by the lighting device. Specifically, the electric bracket includes a first motor for driving the lighting device to rotate obliquely, and a second motor for driving the lighting device to rotate in a translation manner.

The control parameter may be an angular range of pan rotation, an angular range of tilt rotation, a locked-rotor calibration parameter, and an origin reset calibration parameter.

It should be noted that the angular range of the pan rotation refers to an angular range in which the electric bracket is rotated translationally after the lighting device has an accessory therein, that is, may be varied according to the characteristics of the accessory. The angular range of the tilt rotation refers to an angular range in which the electric bracket is rotated obliquely after the lighting device has the accessory therein, that is, may be varied according to the characteristics of the accessory.

The locked-rotor calibration parameter refers to a parameter in which a motor in the electric bracket is calibrated during the locked-rotor action thereof. The locked-rotor calibration parameter may be set corresponding to the accessory. For example, differences exist in the influences of various accessories on the whole lighting device. When the locked-rotor calibration is performed, this difference corresponds to the parameters of controlling the motor, such as a motor current, a voltage and a frequency of the motor, a motor power, a motor speed, and the like. Thus, the voltage and the frequency of the motor are gradually increased or decreased to reduce impact and stress of the electric bracket during start-up or stop of the electric bracket, so it is facilitate to avoid the locked-rotor action; or the motor power is reduced to prevent overload to avoid the locked-rotor action, thereby realizing locked-rotor calibration of the electric bracket.

The origin reset calibration parameter is a parameter used for controlling the electric bracket to drive the lighting device to return to the origin position on the electric bracket. The origin position generally means that there is a reference position on the electric bracket to enable accurate control of the position in subsequent movements. By means of the origin reset calibration, the lighting device with the accessory can be returned to the origin position on the electric bracket, so that the subsequent various rotations of the lighting device have a reference with respect to the origin position, and the subsequent overall movement can be controlled, which avoids the situation that the position is out of control due to loss of the reference position.

In one embodiment, the origin position of the electric bracket may be a particular constant position, and may be a mechanical stopper, a position where the sensor is located, or other indicative position. In another embodiment, the origin position of the electric bracket may be varied according to the characteristics of the accessory. That is, the origin position corresponding to the lighting device may be adaptably changed according to the accessory thereon, because the influences of various accessories on the lighting device as a whole are different. Since the lamp body is unchanged and accessories are different, the influences of different accessories on the distribution of the center of gravity of the lighting device are different. So, the corresponding origin positions are set by adapting to the difference of the accessories, and the origin calibration parameter of matching with the accessory is defined, so that the lighting device can have a better distribution of the center of gravity when returning to the origin position, which is more favorable for subsequent rotational movement.

Specifically, the accessory information may be analyzed to determine the control parameters of the electric bracket which are configured for the lighting device, or the control parameters may be extracted from the accessory information. In one example, when an obstacle around the accessory is detected, according to the accessory size in the accessory information and the rotatable angle of the accessory following the electric bracket, it is possible to determine whether or not the accessory on the lighting device touches an obstacle when the rotation of the electric bracket is controlled, thereby obtaining a predetermined result. The control parameter may be determined according to the predetermined result and the accessory information. It will be appreciated that in the present embodiment, the control parameters of the electric bracket which are configured for the lighting device are determined based on the accessory information, so as to subsequently realize automatic control of the lighting device based on the control parameters, thereby improving the control convenience and the efficiency of the lighting system.

At step S40, the electric bracket is calibrated according to the control parameters.

In one particular embodiment, the control parameters include an angular range of pan rotation and an angular range of tilt rotation. The step S40 of calibrating the electric bracket according to the control parameters may include the following steps S401 to S403.

At step S401, it is detected whether an obstacle exists around the accessory.

At step S402, in response to determining that the obstacle is detected, a safety area of the accessory is obtained, in which the safety area is determined according to the accessory information, the angular range of the pan rotation, and the angular range of the tilt rotation.

At step S403, in response to determining that the obstacle is not in the safety area, the electric bracket is calibrated within the angular range of the pan rotation and the angular range of the tilt rotation.

The safety area refers to a maximum range of the electric bracket in which an accessory of a lighting device does not touch an obstacle when the electric bracket drives the lighting device to move in a case where the obstacle around the accessory is detected.

Specifically, it is possible to detect whether an obstacle exists around the accessory by the infrared distance measuring sensors mounted on the lighting device and/or the electric bracket. Further, it is possible to determine the safety area according to the accessory size in the accessory information, the angular range of the pan rotation of the electric bracket, and the angular range of the tilt rotation of the electric bracket when the obstacle is detected. Illustratively, the range of motion of the electric bracket can be determined based on the angular range of pan rotation of the electric bracket and the angular range of tilt rotation of the electric bracket, and the safety area can be determined in combination with the range of motion as well as the size of the accessory and the reserved size. When the obstacle is not in the safety area, it indicates that when the electric bracket moves to drive the lighting device to move according to the control parameters, the accessory of the lighting device does not touch the obstacle, and the electric bracket is controlled. That is, the electric bracket is calibrated within the angular range of the pan rotation and the angular range of tilt rotation. It will be appreciated that in the present embodiment, the accessory information and the control parameters are used to prejudge whether the accessory moves against an obstacle or not, and the electric bracket is controlled according to the prejudgment result. So, the problem that the accessory may be damaged by the obstacle due to direct calibration of the electric bracket is avoided, and the safety and the accuracy of controlling the lighting system are improved.

It should be noted that if the obstacle is in the safety area, it indicates that when the electric bracket moves to drive the lighting device to move according to the control parameters, the accessory of the lighting device touches the obstacle. At this time, the controller generates a warning message to ensure the safety of the accessory.

In a particular embodiment, the control parameters include a locked-rotor calibration parameter and an origin reset calibration parameter. The method may include the following steps S404 to S405. At step S404, a first calibration interface for performing locked-rotor calibration on the electric bracket is provided, in which the first calibration interface is used to receive a locked-rotor calibration instruction input by the user side, if the locked-rotor calibration instruction is received, the locked-rotor calibration on the electric bracket is performed based on the locked-rotor calibration parameter.

At step S405, a second calibration interface for performing origin reset calibration on the electric bracket is provided, in which the second calibration interface is configured to receive an origin reset calibration instruction input by the user side, if the origin reset calibration instruction is received, the origin reset calibration on the electric bracket is performed based on the origin reset calibration parameter.

Here, the locked-rotor calibration parameter and the origin reset calibration parameter are described at step S30 in the present embodiment. The locked-rotor calibration instruction is an instruction sent by the user side to the controller for realizing the locked-rotor calibration of the motor in the electric bracket during the locked-rotor action. The origin reset calibration instruction is an instruction sent by the user side to the controller for realizing that the electric bracket moves to drive the lighting device move to return to the origin position on the electric bracket. Both the first calibration interface and the second calibration interface are user interfaces of the controller. The first calibration interface is a UI for providing locked-rotor calibration for the electric bracket. The UI may include two options, such as a YES option and a NO option. If the YES option is selected by the user side, the controller receives a locked-rotor calibration instruction. The second calibration interface is a UI for providing origin reset calibration for the electric bracket.

Specifically, the controller provides the first calibration interface for performing locked-rotor calibration on the electric bracket, and the first calibration interface is used for receiving the locked-rotor calibration instruction input by the user side. When the locked-rotor calibration instruction input by the user side is received, the controller performs locked-rotor calibration on the electric bracket according to the locked-rotor calibration parameter, so as to avoid the locked-rotor action of the motor in the electric bracket, and further improve the control effect on the lighting system. The controller further provides a second calibration interface for performing origin reset calibration on the electric bracket, and the second calibration interface is used for receiving an origin reset calibration instruction input by the user side. When the origin reset calibration instruction is received, the controller performs origin reset calibration on the electric bracket according to the origin reset calibration parameter, so that the control of the electric bracket to drive the lighting device to move to the origin position on the electric bracket is realized. So, subsequent various rotations of the lighting device have reference significance with respect to the origin position, the subsequent overall movement is ensured to be controllable, and the control effect on the lighting system is further improved.

In a particular embodiment, the method may further includes the steps S50 to S60.

At step S50, an unlocking instruction for the angular range of the pan rotation and the angular range of the tilt rotation is received.

At step S60, a filling interface for the angular range of the pan rotation and the angular range of the tilt rotation is provided according to the unlocking instruction, so that a user side inputs a target angular range of the pan rotation and a target angular range of the tilt rotation to the filling interface.

The unlocking instruction is an instruction sent by the user side to the controller for unlocking the angular range of the pan rotation and the angular range of the tilt rotation in the control parameters.

Specifically, when the unlocking instruction is received, the controller provides a filling interface for the angular range of the pan rotation and the angular range of the tilt rotation, so that the user side inputs the target angular range of the pan rotation and the target angular range of the tilt rotation to the filling interface. So, the angular range of the pan rotation and the angular range of the tilt rotation in the control parameters are unlocked, respectively, and are constant to be the target angular range of the pan rotation and the target angular range of the tilt rotation, respectively. So, the accurate control of the lighting system is satisfied at different scenes, thereby further improving the control efficiency of the lighting system.

The above control method for the lighting system includes steps of receiving a control instruction for the electric bracket; acquiring accessory information of the accessory based on the control instruction; determining control parameters of the electric bracket which are configured for the lighting device, based on the accessory information; and calibrating the electric bracket based on the control parameters. In this way, the automatic control of the lighting system is realized, the on-site manual control is not required, and the control efficiency, the convenience and the safety of the lighting system are greatly improved.

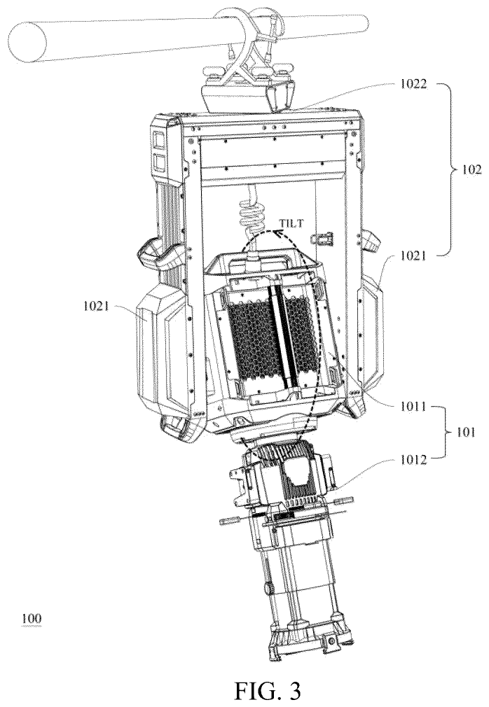

As shown in FIGS. 3-5, in one embodiment, it is provided a lighting system 100 including a lighting device 101, an electric bracket 102, and a controller (not shown). The electric bracket 102 is communicatively connected to the controller. The lighting device 101 is mounted on the electric bracket 102, and the electric bracket 102 is used for adjusting the angle of the lighting device 101. The lighting device 101 includes a lamp body 1011 and an accessory 1012 that are interconnected. The lighting device 101 is used for emitting light. The accessory 1012 is used for adjusting the light emitted by the lamp body 1011. The controller is configured to acquire accessory information of the accessory 1012, determine control parameters of the electric bracket 102 which are configured for the lighting device 101 based on the accessory information, and transmit the control parameters to the electric bracket 102. The electric bracket 102 calibrates itself in accordance with the control parameters when receiving the control parameters, so as to drive the lighting device 101 to move to adjust the light emitted by the lighting device 101.

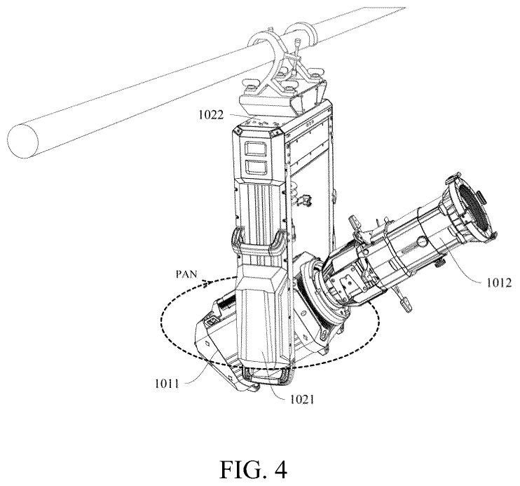

In one example, as shown in FIGS. 3 and 4, which are schematic diagrams of the application of a lighting system mounted on a truss, the application scene may be suitable for hoisting lighting. The electric bracket 102 includes a first motor 1021 and a second motor 1022. The first motor 1021 is used for driving the lighting device 101 to rotate obliquely in its entirety. Since the lighting device 101 includes a lamp body 1011 and an accessory 1012 that are connected to each other, as shown in FIG. 3, in one embodiment, the electric bracket 102 may be rotatably connected to the lamp body 1011, and the accessory 1012 rotates obliquely when the first motor 1021 drives the lamp body 1011 to rotate obliquely in its entirety. In another embodiment, the electric bracket 102 may be rotatably connected to the accessory 1012, and the lamp body 1011 also rotates obliquely when the first motor 1021 drives the accessory 1012 to rotate obliquely in its entirety. It should be noted that the electric bracket 102 is selected to be rotatably connected to the lamp body 1011 or the accessory 1012 based on the distribution of the center of gravity of the lighting device 101, that is, based on the weights of both the lamp body 1011 and the accessory 1012.

The second motor 1022 is used to drive the overall translational rotation of the lighting device 101. The electric bracket 102 may include two portions rotatably connected to each other. The lighting device 101 and the second motor 1022 may be distributed in either of the two portions. The rotation of the second motor 1022 causes the two portions of the electric bracket 102 to rotate relative to each other, thereby realizing the pan rotation of the lighting device 101.

FIG. 3 is a schematic diagram showing a state in which the first motor 1021 of the electric bracket 102 drives the lighting device 101 to perform the TILT (oblique) rotation when the control parameter is the angular range of tilt rotation. FIG. 4 is a schematic diagram showing a state in which the second motor 1022 in the electric bracket 102 drives the lighting device 101 to perform PAN (translation) rotation when the control parameter is the angular range of pan rotation.

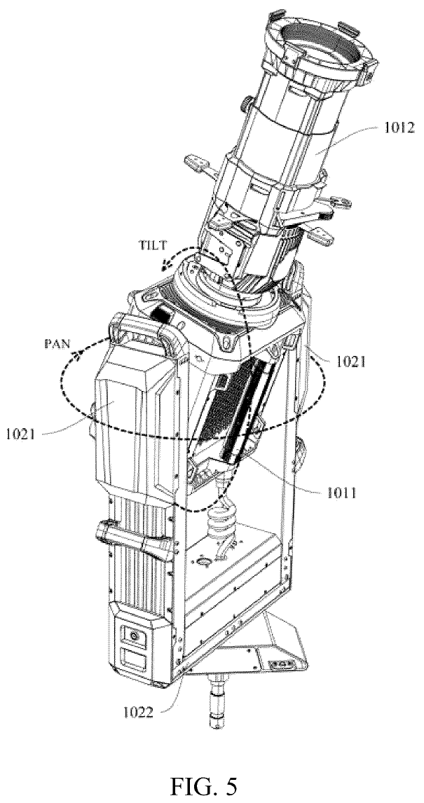

In another example, as shown in FIG. 5, which is a schematic diagram of the application of a lighting system mounted on a floor bracket, the application scene may be suitable for floor lighting. The electric bracket 102 includes a first motor 1021 and a second motor 1022. The first motor 1021 is configured to drive the lighting device 101 to rotate obliquely as a whole, and the second motor 1022 is configured to drive the lighting device 101 to rotate in a translational manner as a whole. FIG. 5 is a schematic diagram of a state in which the first motor 1021 of the electric bracket 102 drives the lighting device 101 to perform the TILT (oblique) rotation when the control parameter is the angular range of tilt rotation, and a schematic diagram of a state in which the second motor 1022 of the electric bracket 102 drives the lighting device 101 to perform the PAN (translational) rotation when the control parameter is the angular range of pan rotation.

Specifically, the controller acquires the accessory information of the accessory 1012, and determines the control parameters of the electric bracket 102 which are configured for the lighting device 101 according to the accessory information, and transmits the control parameters to the electric bracket 102. When the electric bracket 1012 receives the control parameters, the electric bracket 102 calibrates itself according to the control parameters to drive the lighting device 101 to move, thereby adjusting the light emitted by the lighting device 101.

In a particular embodiment, the lighting system further includes a distance measuring sensors disposed on the electric bracket and/or the lighting device. The distance measuring sensors are in communication with the controller. The distance measuring sensor is configured to detect whether an obstacle exists around the accessory, and send a detection result to the controller. The controller is further configured to calibrate the electric bracket according to the detection result and the accessory information after receiving the detection result.

The distance measuring sensor may be an infrared distance measuring sensor for continuously detecting an obstacle around an accessory, and generating a detection result. The detection result includes two kinds of results: presence of an obstacle and position information of the obstacle, and absence of the obstacle. The distance measuring sensor sends the detection result to the controller. After receiving the detection result, the controller calibrates the electric bracket according to the detection result and the accessory information, thereby further realizing remote automatic control of the lighting device, and improving convenience and safety of controlling the lighting device.

In a particular embodiment, the controller includes an input interface and a processor. The input interface is used for providing various interfaces for a user to operate. The processor is configured to perform a calibration operation on the electric bracket after receiving an operation instruction of the input interface.

The various interfaces may include interfaces such as an accessory information selection interface, a control parameter filling interface, a first calibration interface for performing locked-rotor calibration on the electric bracket, and a second calibration interface for performing origin reset calibration on the electric bracket.

Specifically, the input interface is used to provide various interfaces for a user to operate, such as an operation of selecting accessory information, an operation of inputting a control parameter, an operation of determining to perform locked-rotor calibration, and an operation of determining to perform origin reset calibration. After receiving an operation instruction of the input interface, the processor executes a calibration operation on the electric bracket, thereby realizing automatic control of the lighting device, enhancing interaction between the lighting device and the user side through the input interface, and further realizing visual control of the lighting device.

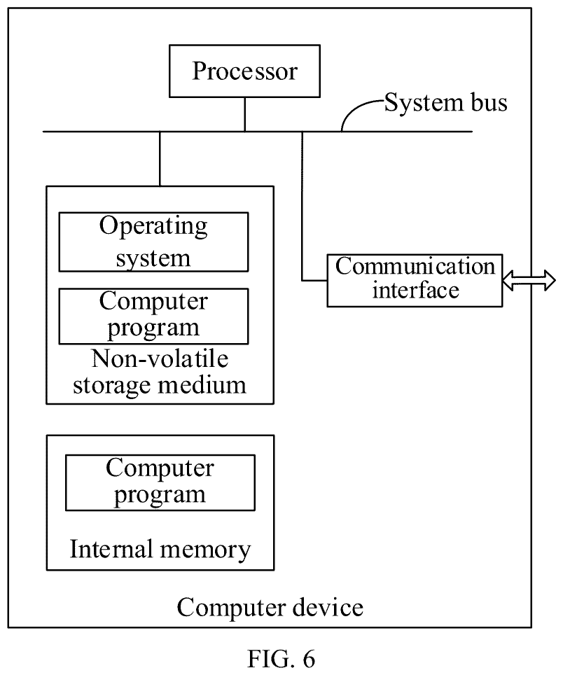

FIG. 6 illustrates an internal structural diagram of a computer device according to embodiments of the present application. The computer device may in particular be a server including, but not limited to, a high-performance computer and a high-performance computer cluster. As shown in FIG. 6, the computer device includes a processor, a memory, and a network interface connected by a system bus. The memory includes a non-volatile storage medium and an internal memory. The non-volatile storage medium of the computer apparatus stores an operating system and may also store computer programs which, when executed by a processor, enables the processor to implement a control method for the lighting system. The internal memory may also store computer programs which, when executed by the processor, causes the processor to execute the control method for the lighting system. It will be appreciated by those skilled in the art that the structure shown in FIG. 6 is a block diagram of only a part of the structure which is associated with the solution of the present application, which does not constitute a definition of the computer device to which the solution of the present application is applied. A computer device may particularly include more or less components than those shown in the figures, or may combine certain components, or have a different component arrangement.

In one embodiment, the control method for the lighting system provided in the present application may be implemented in the form of computer programs that may run on a computer device as shown in FIG. 6.

A computer device includes a memory, a processor, and computer programs stored in the memory and executable on the processor. The processor implements the steps in the control method for the lighting system when executing the computer programs.

A computer readable storage medium storing computer programs which, when executed by a processor, implement the steps in the control method for the lighting system.

It will be appreciated by those of ordinary skill in the art that all or a portion of the flow of implementing the methods of the embodiments described above may be accomplished by a computer program that may be stored in a non-volatile computer readable storage medium and that the program, when executed, may include the flow of the embodiments of the methods described above. Any reference to a memory, storage, database or other medium used in the embodiments provided herein may include non-volatile and/or volatile memory. Non-volatile memory may include read only memory (ROM), programmable ROM (PROM), electrically programmable ROM (EPROM), electrically erasable programmable ROM (EEPROM), or flash memory. Volatile memory may include random access memory (RAM) or external cache memory. By way of illustration and not limitation, RAM is available in a variety of forms, such as static RAM (SRAM), dynamic RAM (DRAM), synchronous DRAM (SDRAM), double data rate SDRAM (DDRSDRAM), enhanced SDRAM (ESDRAM), synchronous link (Synchlink) DRAM (SLDRAM), memory bus (Rambus) direct RAM (RDRAM), direct memory bus dynamic RAM (DRDRAM), and memory bus dynamic RAM (RDRAM).

The technical features in the above embodiments may be combined arbitrarily. For the sake of brevity, not all possible combinations of the technical features in the above embodiments have been described. However, the combinations of these technical features should be considered to be within the scope of the present description as long as they do not contradict each other.

The above-described examples, which represent only a few embodiments of the present application, are described in more detail and detail, but are not therefore to be construed as limiting the scope of the patent application. It should be noted that several variations and modifications may be made by those of ordinary skill in the art without departing from the spirit and scope of the present application. Accordingly, the scope of protection of the present patent should be governed by the appended claims.

What is claimed is:

1. A control method for a lighting system, the lighting system comprising:
a lighting device comprising:
an lamp body for emitting light; and
an accessory interconnected with the lamp body, and configured to adjust the light emitted by the lamp body; and
an electric bracket on which the lighting device is mounted, wherein the electric bracket is configured to adjust an angle of the lighting device;
wherein the control method comprises:
receiving a control instruction for the electric bracket;
acquiring accessory information of the accessory based on the control instruction;
determining control parameters of the electric bracket which are configured for the lighting device, based on the accessory information; and
calibrating the electric bracket based on the control parameters.

2. The control method for the lighting system according to claim 1, wherein the accessory comprises one of a target accessory with pre-configured accessory information, a known accessory with pre-configured accessory information, and an unknown accessory with un-configured accessory information, wherein the target accessory is further provided with an electronic contact for identification and detection;
the acquiring accessory information of the accessory based on the control instruction comprises:
sending a detection instruction to the accessory; and
in response to determining that a detected accessory by the electronic contact is the target accessory, identifying and acquiring the accessory information of the target accessory by the electronic contact.

3. The control method for the lighting system according to claim 2, wherein the acquiring accessory information of the accessory based on the control instruction comprises:
in response to determining that the detected accessory is not the target accessory, providing a selection interface for the unknown accessory and the known accessory for a user side to select;
in response to determining that the user side selects the known accessory, acquiring the accessory information of the known accessory selected by the user side on the selection interface.

4. The control method for the lighting system according to claim 3, wherein the method comprises:
in response to determining that the user side selects the unknown accessory, providing a filling interface for the control parameters of the electric bracket which are configured for unknown accessory, to enable the user side to input the control parameters to the filling interface.

5. The control method for the lighting system according to claim 1, wherein the control parameters comprise a locked-rotor calibration parameter and an origin reset calibration parameter;
the method comprises:
providing a first calibration interface for performing locked-rotor calibration on the electric bracket, wherein the first calibration interface is configured to receive a locked-rotor calibration instruction from a user side;
in response to determining that the locked-rotor calibration instruction is received, performing the locked-rotor calibration on the electric bracket based on the locked-rotor calibration parameter; providing a second calibration interface for performing origin reset calibration on the electric bracket, wherein the second calibration interface is configured to receive an origin reset calibration instruction from the user side;
in response to determining that the origin reset calibration instruction is received, performing the origin reset calibration on the electric bracket based on the origin reset calibration parameter.

6. The control method for the lighting system according to claim 1, wherein the control parameters comprise an angular range of pan rotation and an angular range of tilt rotation, and the calibrating the electric bracket based on the control parameters comprises:
detecting whether an obstacle exists around the accessory;
in response to determining that the obstacle is detected, obtaining a safety area of the accessory which is determined according to the accessory information, the angular range of the pan rotation, and the angular range of the tilt rotation;
in response to determining that the obstacle is not in the safety area, calibrating the electric bracket within the angular range of the pan rotation and the angular range of the tilt rotation.

7. The control method for the lighting system according to claim 6, further comprising:
receiving an unlocking instruction for the angular range of the pan rotation and the angular range of the tilt rotation;
providing a filling interface for the angular range of the pan rotation and the angular range of the tilt rotation according to the unlocking instruction, such that a user side inputs a target angular range of the pan rotation and a target angular range of the tilt rotation to the filling interface.

8. A lighting system comprising a lighting device, an electric bracket, and a controller, the electric bracket being communicatively connected to the controller;
wherein the lighting device is mounted on the electric bracket, and the electric bracket is configured to adjust an angle of the lighting device;
the lighting device comprises:
a lamp body for emitting light, and
an accessory interconnected with the lamp body, wherein the accessory is configured to adjust the light emitted by the lamp body;
the controller is configured to acquire accessory information of the accessory, determine control parameters of the electric bracket which are configured for the lighting device according to the accessory information, and send the control parameters to the electric bracket;
the electric bracket is configured to calibrate according to the control parameters in response to receiving the control parameters, so as to drive the lighting device to move to adjust the light emitted by the lighting device.

9. The lighting system according to claim 8, further comprising distance measuring sensors disposed on the electric bracket and/or the lighting device, wherein the distance measuring sensors are in communication with the controller;
the distance measuring sensors are configured to detect whether an obstacle exists around the accessory, and send a detection result to the controller;
the controller is further configured to calibrate the electric bracket according to the detection result and the accessory information after receiving the detection result.

10. The lighting system according to claim 8, wherein the controller comprises an input interface and a processor;
the input interface is configured to provide interfaces for a user side to operate;
the processor is configured to perform a calibration operation on the electric bracket after receiving an operation instruction from the input interface.

11. A computer readable storage medium storing computer programs, and coupled to a processor, wherein a lighting system comprising:
a lighting device comprising:
an lamp body for emitting light; and
an accessory interconnected with the lamp body, and configured to adjust the light emitted by the lamp body; and
an electric bracket on which the lighting device is mounted, wherein the electric bracket is configured to adjust an angle of the lighting device;
wherein the computer programs are executed by the processor to cause the processor to perform operations comprising:
receiving a control instruction for the electric bracket;
acquiring accessory information of the accessory based on the control instruction;
determining control parameters of the electric bracket which are configured for the lighting device, based on the accessory information; and
calibrating the electric bracket based on the control parameters.

12. The computer readable storage medium according to claim 11, wherein the accessory comprises one of a target accessory with pre-configured accessory information, a known accessory with pre-configured accessory information, and an unknown accessory with un-configured accessory information, wherein the target accessory is further provided with an electronic contact for identification and detection;
the acquiring accessory information of the accessory based on the control instruction comprises:
sending a detection instruction to the accessory; and
in response to determining that a detected accessory by the electronic contact is the target accessory, identifying and acquiring the accessory information of the target accessory by the electronic contact.

13. The computer readable storage medium according to claim 12, wherein the acquiring accessory information of the accessory based on the control instruction comprises:
in response to determining that the detected accessory is not the target accessory, providing a selection interface for the unknown accessory and the known accessory for a user side to select;
in response to determining that the user side selects the known accessory, acquiring the accessory information of the known accessory selected by the user side on the selection interface.

14. The computer readable storage medium according to claim 13, wherein the operations comprise:
in response to determining that the user side selects the unknown accessory, providing a filling interface for the control parameters of the electric bracket which are configured for the unknown accessory, to enable the user side to input the control parameters to the filling interface.

15. The computer readable storage medium according to claim 11, wherein the control parameters comprise a locked-rotor calibration parameter and an origin reset calibration parameter;
the operations comprise:
providing a first calibration interface for performing locked-rotor calibration on the electric bracket, wherein the first calibration interface is configured to receive a locked-rotor calibration instruction from a user side;
in response to determining that the locked-rotor calibration instruction is received, performing the locked-rotor calibration on the electric bracket based on the locked-rotor calibration parameter; providing a second calibration interface for performing origin reset calibration on the electric bracket, wherein the second calibration interface is configured to receive an origin reset calibration instruction from the user side;
in response to determining that the origin reset calibration instruction is received, performing the origin reset calibration on the electric bracket based on the origin reset calibration parameter.

16. The computer readable storage medium according to claim 11, wherein the control parameters comprise an angular range of pan rotation and an angular range of tilt rotation, and the calibrating the electric bracket based on the control parameters comprises:
detecting whether an obstacle exists around the accessory;
in response to determining that the obstacle is detected, obtaining a safety area of the accessory which is determined according to the accessory information, the angular range of the pan rotation, and the angular range of the tilt rotation;
in response to determining that the obstacle is not in the safety area, calibrating the electric bracket within the angular range of the pan rotation and the angular range of the tilt rotation.

17. The computer readable storage medium according to claim 16, the operations comprise:
receiving an unlocking instruction for the angular range of the pan rotation and the angular range of the tilt rotation;
providing a filling interface for the angular range of the pan rotation and the angular range of the tilt rotation according to the unlocking instruction, such that a user side inputs a target angular range of the pan rotation and a target angular range of the tilt rotation to the filling interface.
